(19) United States
(12) Patent Application Publication
(10) Pub. No.: US 2025/0380631 A1
(43) Pub. Date: Dec. 18, 2025

(54) FERTILISER SPREADER FOR SPREADING GRANULAR FERTILISER ON AGRICULTURAL LAND

(71) Applicant: AMAZONEN-WERKE H. DREYER SE & CO. KG, Hasbergen (DE)

(72) Inventor: Per-Christian Heisel, Osnabrueck (DE)

(21) Appl. No.: 18/745,347

(22) Filed: Jun. 17, 2024

(51) Int. Cl. A01C 17/00

(52) U.S. Cl. CPC A01C 17/008; A01C 17/001

(57) ABSTRACT

The invention relates to a fertilizer spreading machine for spreading granular fertilizer on an agricultural land, comprising: a discharge device having at least one disc arrangement which is designed to discharge fertilizer onto the agricultural land, a sensor arrangement comprising a plurality of sensors, wherein each of the plurality of sensors is designed to detect the fertilizer discharged by the discharge device by emitting detection waves in the direction of the fertilizer discharged by the discharge device and receiving detection waves reflected by the fertilizer and to provide a sensor signal dependent on the intensity of the detection waves reflected by the fertilizer, and a control device which is designed to achieve an intended fertilizer distribution on the agricultural land depending on the sensor signals provided by sensors of the sensor arrangement causes a change in the disc speed on one or more spreading discs of the disc arrangement and/or the point at which the fertilizer is delivered to one or more spreading discs of the disc arrangement.

The invention relates to a fertilizer spreader according to the preamble of claim 1, a system for applying material to be spread to an agricultural land according to the preamble of claim 2, an agricultural spreading machine according to the preamble of claim 10, and a method for applying material to be spread to an agricultural land according to the preamble of claim 11.

The applying of material to be spread to an agricultural land is usually done using a spreading machine, which discharges material to be spread onto the agricultural area via a discharge device. Machine types already available on the market use a sensor arrangement to detect the material to be spread which has been discharged by the discharging device by receiving detection waves reflected by the material to be spread and to provide at least one sensor signal which depends on the intensity of the detection waves reflected by the material to be spread.

To achieve an intended distribution on agricultural land of material to be spread, one or more setting parameters of the discharge device that influence the distribution of the material to be spread are then adjusted depending on the sensor signal provided by the sensor arrangement.

With the known systems, the material to be spread can so far only be detected in one detection plane, so there is still considerable potential for improvement in terms of the precise adjustment of the discharge device.

The underlying object of the invention is therefore to further increase the precision of spreading material to be spread on an agricultural land.

The object is achieved by a fertilizer spreader of the type mentioned at the outset, wherein the control device of the fertilizer spreader according to the invention is designed to evaluate the intensity of the detection waves reflected by the fertilizer depending on the reflection distance between the respective sensor and the fertilizer to determine the fertilizer distribution in two detection planes spaced apart from one another.

The object is further achieved by a system of the type mentioned at the outset, wherein the control device of the system according to the invention is designed to evaluate the intensity of the detection waves reflected by the material to be spread depending on the reflection distance to the material to be spread to determine the density distribution of the material to be spread in two detection planes spaced from one another.

By determining the density distribution of the material to be spread in two detection planes that are spaced apart from one another, the discharge or flight behaviour of the material to be spread can be detected much more precisely, so that the adjustment of the discharge device can also be carried out with a significantly increased accuracy.

The setting parameters changed to achieve the intended distribution of the material to be spread on the agricultural land can relate to the delivery point of the material to be spread to one or more spreading discs of a disc arrangement of the discharge device and/or the speed of one or more spreading discs of a disc arrangement of the discharge device. Furthermore, the setting parameters changed to achieve the intended distribution of the material to be spread on the agricultural land can relate to the amount of material to be spread delivered to one or more spreading discs of a disc arrangement of the discharge device and/or the position and/or the length of the centrifugal blades of the one or more spreading discs of a disc arrangement of the discharge device. Furthermore, the setting parameters changed to achieve the intended distribution of the material to be spread on the agricultural land can relate to the discharge angle of the material to be spread and/or the throwing distance of the material to be spread.

The sensor arrangement is preferably also designed to emit the detection waves in the direction of the discharged material to be spread. The density distributions determined refer to two detection planes spaced apart from each other beyond the ground, i.e., the density distribution is determined in two detection planes after discharge by the discharge device and before the material to be spread hits the ground.

The intensity of the detection waves reflected by the material to be spread is proportional to the density of the material to be spread at the reflection distance examined. The detection waves have, for example, a wavelength in the range between 0.001 mm and 50 mm. By evaluating the control device, two material spreading fans can be detected separately from one another with just one sensor arrangement. The reflection distance can be the distance between the emission location of the detection waves and the material to be spread. Alternatively, the reflection distance can be the distance between a reference location and the material to be spread. The material to be spread can be, for example, granular fertilizer.

The control device is preferably an electronic control device and/or comprises an electronic data processing device. The control device can be an operating terminal or comprise an operating terminal. The operating terminal can be a portable handheld device.

In addition, a system according to the invention is preferred in which the control device is set up to accumulate the intensity of the detection waves reflected by the material to be spread over the reflection distance to the material to be spread to determine the density distribution of the material to be spread in the two spaced-apart detection planes. By accumulating the intensity of the detection waves reflected by the material to be spread over the reflection distance, a curve is created from which can be determined the density distribution of two material spreading fans that are spaced apart in the detection direction. The reflection distance can be determined, for example, using the signal runtime. The curve has a gradient of at least approximately zero in the distance range between the two material spreading fans, although a slight deviation from the gradient of zero can occur due to ricochets and flying material. This region is therefore particularly important for separating the two material spreading fans from one another in terms of signal technology without complicated filters. The curve has a positive gradient in the two detection planes, i.e. in the distance range in which are located the two material spreading fans. The gradients can be used to precisely derive the density of the material to be spread, and therefrom the distribution of the material to be spread.

In a further preferred embodiment of the system according to the invention, the sensor arrangement comprises a plurality of sensors which are spaced apart from one another and/or have different orientations, each of which is designed to detect the material to be spread discharged by the discharge device by receiving detection waves reflected by the material to be spread and to provide a sensor signal which depends on the intensity of the detection waves reflected by the material to be spread. The sensors are therefore aligned such that the detection directions of the respective sensors intersect the trajectory of the material to be spread, in particular exactly once per disc arrangement. The sensors are aligned such that the detection directions at least for the most part cover the usual angular range in which the material to be spread is discharged. The sensors can be radar sensors, for example.

In another preferred embodiment of the system according to the invention, the control device is designed to determine the density distribution of the material to be spread and/or the fan shape and/or the transverse distribution of the material to be spread from a material spreading fan to be spread crossing the first detection plane from the sensor signals of the plurality of sensors. Alternatively or additionally, the control device is designed to determine from the sensor signals of the multiple sensors the density distribution of the material to be spread and/or the fan shape and/or the transverse distribution of the material to be spread from a second material spreading fan crossing the second detection plane. From the signals of the respective sensors, the control device derives, for example, a first density value for the first material spreading fan in the first detection plane and a second density value for the second material spreading fan in the second detection plane. The density distribution of the material to be spread and/or the fan shape and/or the transverse distribution of the material to be spread of the first material spreading fan can be calculated from the plurality of first density values. The density distribution of the material to be spread and/or the fan shape and/or the transverse distribution of the material to be spread of the second material spreading fan can then be calculated from the plurality of second density values.

A system according to the invention is also advantageous in which the control device is set up to regulate a first target distribution of the material to be spread in the first detection plane via a changing of one or more setting parameters of the ejection device and/or to regulate a second target distribution of the material to be spread in the second detection plane. To regulate the first target distribution of the material to be spread in the first detection plane, for example, one or more setting parameters of a first disc arrangement of the discharge device are adjusted. These setting parameters can relate to the point at which the material to be spread is delivered onto the one or more discs of the first disc arrangement and/or the speed of the one or more spreading discs of the first disc arrangement. These setting parameters can also relate to the amount of material to be spread delivered to the one or more spreading discs of the first spreading disc arrangement and/or the position and/or the length of the centrifugal blades of the one or more spreading discs of the first disc arrangement. These setting parameters can also relate to the discharge angle and/or the throwing distance of the material to be spread discharged by the first disc arrangement. To regulate the second target distribution of the material to be spread in the second detection plane, for example, one or more setting parameters of a second disc arrangement of the discharge device are adjusted. These setting parameters can relate to the point at which the material to be spread is delivered to the one or more spreading discs of the second disc arrangement and/or the speed of the one or more spreading discs of the second disc arrangement. These setting parameters can also relate to the amount of material to be spread delivered to the one or more spreading discs of the second disc arrangement and/or the position and/or the length of the centrifugal blades of the one or more spreading discs of the second disc arrangement. These setting parameters can also relate to the discharge angle and/or the throwing distance of the material to be spread discharged by the second disc arrangement.

In addition, a system according to the invention is preferred in which the discharge device has a first disc arrangement for generating a first material spreading fan and a second disc arrangement for generating a second material spreading fan, wherein the first material spreading fan crosses the first detection plane and the second material spreading fan crosses the second detection plane. The sensors of the sensor arrangement are in particular aligned such that the detection directions of the respective sensors intersect the flight path of the material to be spread, exactly once per disc arrangement. The disc arrangements can each comprise one or more spreading discs. The disc arrangements are preferably arranged one above the other, i.e., arranged to be spaced apart from one another in the vertical direction.

In another preferred embodiment, the system according to the invention has a first storage container for storing a first material to be spread and/or a first delivery device for delivering the first material to be spread stored in the first storage container onto the first disc arrangement. Alternatively or additionally, the system has a second storage container for storing a second material to be spread and/or a second delivery device for delivering the second material to be spread stored in the second storage container onto the second disc arrangement. The first material to be spread differs from the second material to be spread in particular with regard to grain size and/or grain shape and/or grain weight. The first material to be spread can also differ from the second material to be spread in terms of the surface texture. The surface texture has a strong influence on the flight characteristics due to friction, in particular on the disc arrangement and/or with regard to air resistance. The first material to be spread can be a first fertilizer. The second material to be spread can be a second fertilizer. The disc arrangements are fed with material to be spread from different containers, so two different types of material to be spread can be spread separately from one another. The first and second material to be spread can be the same fertilizer, for example to achieve a larger working width and/or a larger application rate with sufficiently precise transverse distribution.

In a further development of the system according to the invention, the discharge device has a disc arrangement for producing a material spreading fan, wherein the material spreading fan crosses the first detection plane and the second detection plane. Alternatively, the discharge device comprises a disc arrangement, wherein when a mixture of material to be spread comprising a first material to be spread and a second material to be spread is delivered, a first material spreading fan and a second material spreading fan are formed due to a segregation of the materials to be spread, wherein the first material spreading fan crosses the first detection plane and the second material spreading fan crosses the second detection plane. The disc arrangement can comprise one or more spreading discs. When the material spreading fan crosses the first and second detection planes, the control device can determine the wind influence on the material spreading fan and take this into account when adjusting the discharge device. The system preferably comprises a storage container for storing the mixture of materials to be spread and/or a delivering device for delivering onto the disc arrangement the mixture of material to be spread which are stored in the storage container. The mixture of materials to be spread can be a mixed fertilizer. Due to different properties, a mixed fertilizer often separates quickly so that two separate material spreading fans form during the flight phase.

Alternatively or additionally, the control device can determine the wind influence on the material spreading fan(s) by evaluating the detected density distribution. In particular, an evaluation is made of the gradient of the cumulative intensity of the detection waves reflected by the material to be spread and/or the length of the reflection distance in which the material to be spread is detected. A steep gradient of the cumulative intensity of the detection waves reflected by the material to be spread and/or a short length of the reflection distance in which the material to be spread is detected are characteristic of material to be spread delivered against the direction of the wind or a part of the spreading fan delivered against the direction of the wind, because the distribution is compressed contrary to the normal case without the influence of wind. A flat gradient of the cumulative intensity of the detection waves reflected by the material to be spread and/or a large length of the reflection distance in which the material to be spread is detected are characteristic of material to be spread delivered in the direction of the wind or a part of the spreading fan delivered in the direction of the wind, because the distribution is stretched, contrary to the normal case without wind influence. The control device preferably takes into account the wind influence determined in this way when setting the delivery device.

The invention can therefore relate to a system in which the material to be spread is delivered using only one disc arrangement. In this case, the delivered material to be spread can only form one or more separate material spreading fans during the flight phase. If only one material spreading fan is formed, this material spreading fan crosses the first detection plane and the second detection plane. If several material spreading fans form during the flight phase, one, several or all of the material spreading fans can cross one of the two detection planes or both detection planes. If the material to be spread is spread over several disc arrangements, the material to be spread discharged over the respective disc arrangements can form only one or several material spreading fans. One material spreading fan, several material spreading fans, or all material spreading fans can cross one or both detection levels. Normally, a spreading fan crosses exactly one detection level, so that two spreading fans, in particular those created over two disc arrangements, form two detection levels.

The underlying object of the invention is also achieved by an agricultural spreading machine of the type mentioned at the outset, wherein the system for delivering material to be spread is designed according to one of the embodiments described above. With regard to the advantages and modifications of the agricultural spreading machine according to the invention, reference is first made to the advantages and modifications of the system according to the invention.

The spreading machine is preferably a fertilizer spreader. The spreading machine can be a tractor-mounted machine. The spreading machine can be a towed machine or a carried machine.

The underlying object of the invention is further achieved by a method of the type mentioned at the outset, wherein the control device evaluates the intensity of the detection wave reflected by the material to be spread as a function of the reflection distance to the material to be spread to determine the density distribution of the material to be spread in two detection planes spaced apart from one another. The method for delivering the material to be spread onto an agricultural land is preferably carried out by means of an agricultural spreading machine according to one of the embodiments described above. With regard to the advantages and modifications of the method according to the invention, reference is first made to the advantages and modifications of the spreading machine according to the invention.

In a preferred embodiment of the method according to the invention, the control device accumulates the intensity of the detection waves reflected by the material to be spread over the reflection distance to determine the density distribution of the material to be spread in the two detection planes spaced apart from one another. As part of the accumulation, the control device preferably generates a curve from which can be determined the density distribution of two material spreading fans that are spaced apart from one another in the detection direction.

The method according to the invention is further advantageously developed in that several sensors of the sensor arrangement that are spaced apart from one another and/or have different orientations detect the material to be spread delivered by the discharge device by receiving detection waves reflected by the material to be spread and provide a sensor signal that depends on the intensity of the detection waves reflected by the material to be spread, wherein the method comprises at least one of the following steps: determining the density distribution of the material to be spread and/or the fan shape and/or the transverse distribution of the material to be spread of a first material spreading fan crossing the first detection plane by the control device from the sensor signals of the several sensors; determining the density distribution of the material to be spread and/or the fan shape and/or the transverse distribution of the material to be spread of a material spreading fan crossing the second detection plane by the control device from the sensor signals of the several sensors. The method preferably comprises the derivation of a first density value for the first material spreading fan in the first detection plane and deriving a second density value for the second material spreading fan in the second detection plane. The method can also comprise calculating the density distribution of the material to be spread and/or the fan shape and/or the transverse distribution of the material to be spread of the first material spreading fan from the plurality of density values. The method can also comprise calculating the density distribution of the material to be spread and/or the fan shape and/or the transverse distribution of the material to be spread of the second material spreading fan from the plurality of second density values.

The method according to the invention is further advantageously further developed in that a first target distribution of the material to be spread is regulated in a first detection plane by a changing of one or more setting parameters of the discharge device by the control device. Alternatively or additionally, a second target distribution of the material to be spread is regulated in the second detection plane by a changing of one or more setting parameters of the discharge device by the control device.

A method according to the invention is also advantageous in which the discharge device generates a material spreading fan that crosses the first detection plane and the second detection plane, wherein the method preferably comprises determining the wind influence on the material spreading fan by evaluating the distribution of the material to be spread in the first detection plane and the second detection plane by the control device, wherein the control device preferably takes into account the determined wind influence when setting the discharge device. The control device preferably determines the wind influence separately for each determined material to be spread fan. The control device preferably specifies the wind influence detected by the sensor by taking into account properties of the material to be spread that influence the flight behaviour of the material to be spread. In this context, the control device can, for example, take into account the grain size, the grain weight and/or the surface quality of the material to be spread.

The method according to the invention is further advantageously developed in that the determination of the wind influence on the material spreading fan is carried out by evaluating the gradient of the accumulated intensity of the detection waves reflected by the material to be spread and/or the length of the reflection distance in which the material to be spread is detected.

In a further preferred embodiment of the method according to the invention, when a mixture of material to be spread comprising a first material to be spread and a second material to be spread is delivered, a first material spreading fan and a second material spreading fan are formed due to a segregation of the material to be spread, wherein the first material spreading fan crossing the first detection plane and the second material spreading fan crosses the second detection plane. The method preferably comprises the setting of setting parameters on the delivery device by the control device, through which the material spreading distribution of the first material to be spread in the first detection plane and the material spreading distribution of the second material to be spread in the second detection plane are within a tolerance range. The setting parameters in this case represent a compromise, which allow a first material to be spread and a second material to be spread to be delivered together onto the agricultural land while achieving an acceptable transverse distribution.

Preferred embodiments of the invention are explained and described in more detail below with reference to the accompanying drawings. Therein:

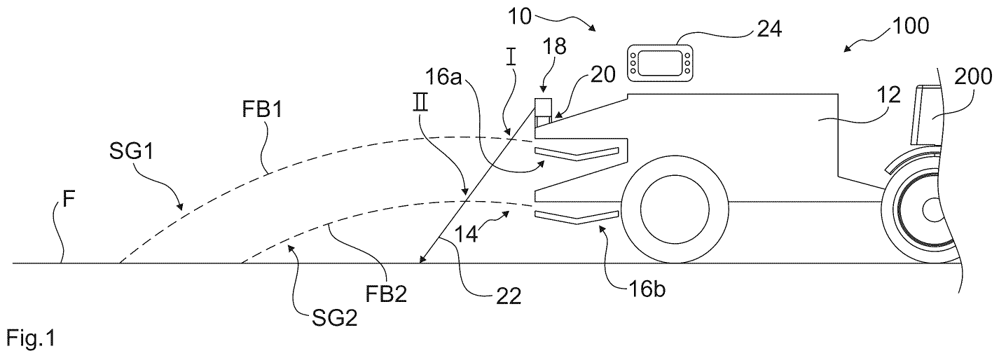

FIG. 1 shows an embodiment of the system according to the invention in a schematic representation;

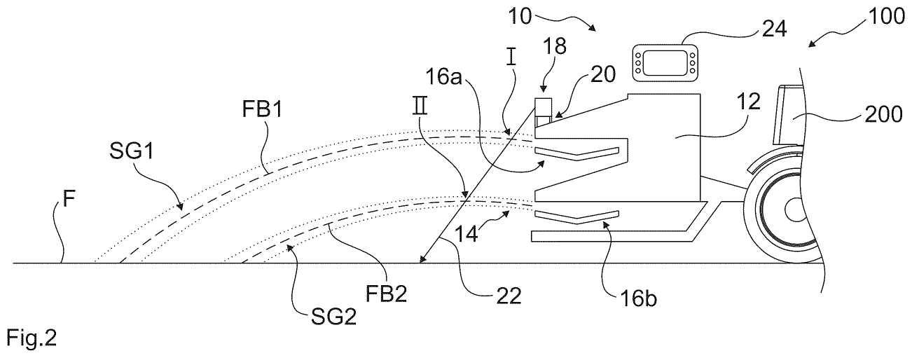

FIG. 2 shows a further embodiment of the system according to the invention in a schematic representation;

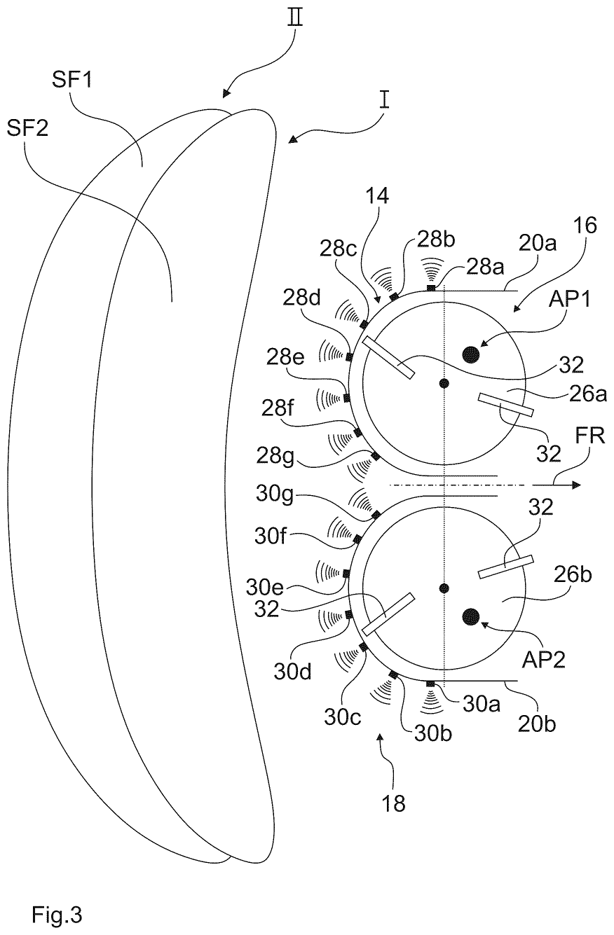

FIG. 3 shows the discharge device of a system according to the invention including the sensor arrangement in a schematic top view;

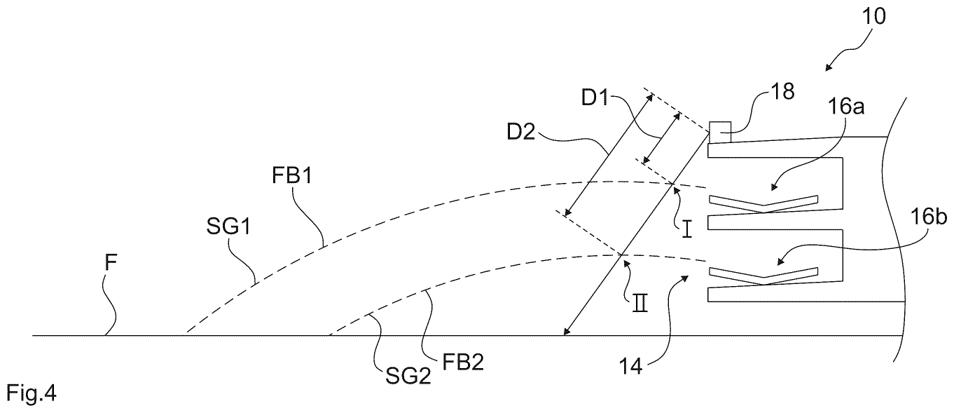

FIG. 4 shows the trajectories of material to be spread discharged by means of a system according to the invention in a schematic side view;

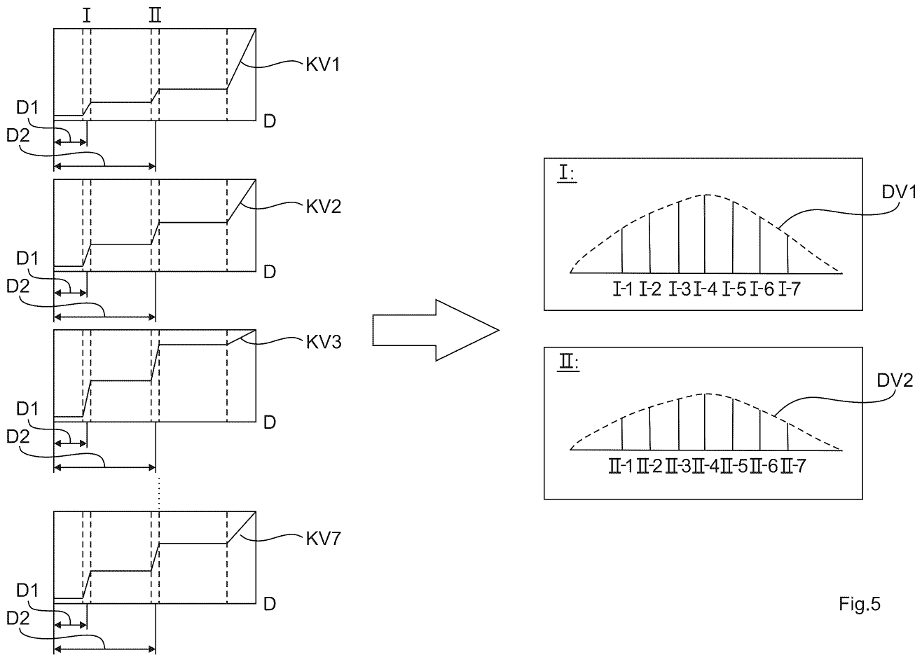

FIG. 5 shows the determination of density distributions of the material to be spread in a schematic representation;

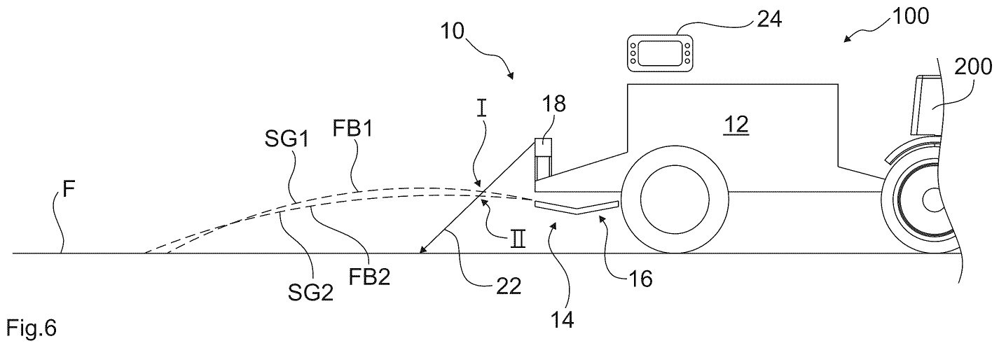

FIG. 6 shows a further embodiment of the system according to the invention in a schematic representation;

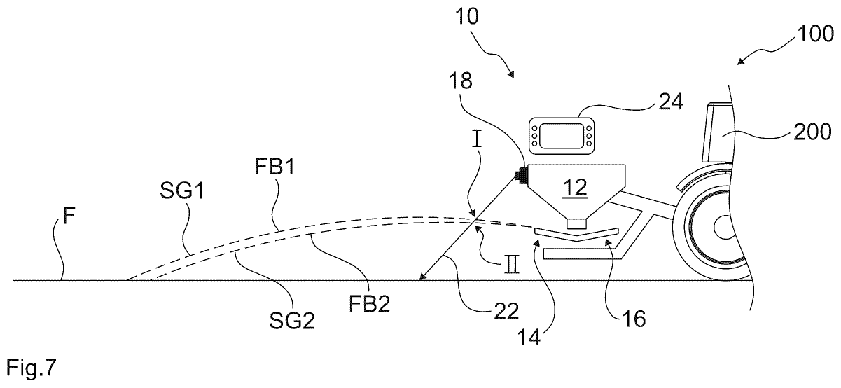

FIG. 7 shows a further embodiment of the system according to the invention in a schematic representation; and

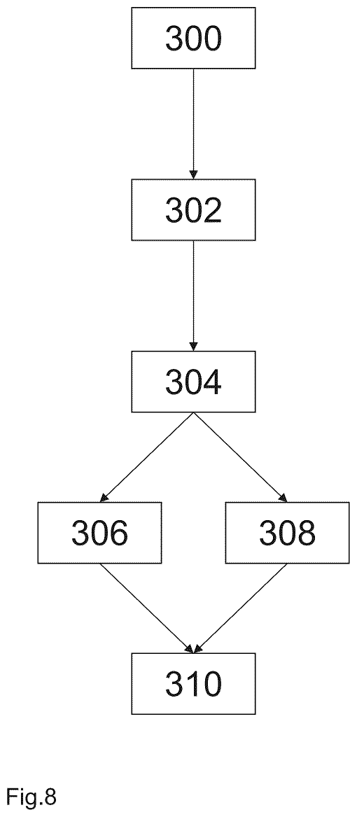

FIG. 8 shows an embodiment of the method according to the invention in a schematic block representation.

FIG. 1 shows an agricultural spreading machine 100 which is designed as a towed fertilizer spreader. The spreading machine 100 is towed by a towing vehicle 200. The towing vehicle 200 and the spreading machine 100 form a machine combination.

The spreading machine 100 comprises a system 10 for delivering material to be spread SG1, SG2 onto an agricultural land F. The system 10 has a discharge device 14, a sensor arrangement 18, and a control device 24.

The discharge device 14 serves to discharge the material to be spread SG1, SG2 onto the agricultural land F. The discharge device 14 is connected to a storage region 12, wherein the storage region 12 comprises two storage containers. A first material to be spread SG1 is stored in a first storage container. A second material to be spread SG2 is stored in a second storage container. The discharge device 14 comprises two disc arrangements 16a, 16b arranged one above the other. The disc arrangements 16a, 16b can comprise one or more spreading discs, via which the material to be spread SG1, SG2 is thrown onto the agricultural land F. The first material to be spread SG1, which is stored in the first storage container, is delivered to the one or more spreading discs of the disc arrangement 16a. The second material to be spread SG2, which is stored in the second storage container, is delivered to the one or more spreading discs of the second disc arrangement 16b.

The material to be spread SG1 delivered via the one or more spreading discs of the first disc arrangement 16a forms a flight path FB1 during the flight phase. The material to be spread SG2 delivered via the one or more spreading discs of the second disc arrangement 16b forms a flight path FB2 during the flight phase.

The sensor arrangement 18 is attached to the main frame of the spreading machine 100 via a sensor holder 20 and is used to detect the material to be spread SG1, SG2 delivered by the discharge device 14. To detect the material to be spread SG1, SG2 discharged by the discharge device 14, the sensor arrangement 18 receives detection waves which have been reflected by the material to be spread SG1, SG2. The sensor arrangement 18 also provides at least one sensor signal which depends on the intensity of the reflected detection waves. So that the material to be spread discharged by the discharge device 14 can be detected by means of the sensor arrangement 18, the detection direction 22 of the sensor arrangement 18 crosses the flight paths FB1, FB2 of the first material to be spread SG1 and the second material to be spread SG2.

The control device 24 is designed to achieve an intended distribution of the material to be spread onto the agricultural land F, depending on the sensor signal provided by the sensor arrangement 18, to cause a change in a setting parameter of the discharge device 14 which influences the distribution of the material to be spread. For this purpose, the control device 24 evaluates the intensity of the detection waves reflected from the material to be spread SG1, SG2 as a function of the reflection distance to the material to be spread SG1, SG2 to determine the density distribution of the material to be spread SG1, SG2 in two detection planes I, II which are spaced apart for one another.

The control device 24 can be an operating terminal, for example. In other embodiments, the control device 24 can also be integrated into the spreading machine 100 or into the towing vehicle 200.

FIG. 2 shows an alternative exemplary embodiment of a system 10 for material to be spread SG1, SG2 to be delivered onto an agricultural land F. In the embodiment shown, the spreading machine 100 is designed as a carried fertilizer spreader. The towing vehicle 200 and the spreading machine 100 form a machine combination. In other respects, the structure of the system 10 essentially corresponds to the structure of the system 10 shown in FIG. 1, wherein it is also indicated that the discharged material to be spread SG1, SG2 has a spatial extent in the detection direction 22, which allows an evaluation of the length of the reflection distance in which the material to be spread is detected.

FIG. 3 shows a disc arrangement 16 of a discharge device 14 comprising two spreading discs 26a, 26b. The disc arrangement 16 moves in the direction of travel FR. The sensor arrangement 18 comprises a first group of sensors 28a-28g, which are assigned to the spreading disc 26a. The sensor arrangement 18 also comprises a second group of sensors 30a-30g, which are assigned to the spreading disc 26b. The sensors 28a-28g, 30a-30g are designed as radar sensors and are attached to the sensor holders 20a, 20b. The sensors 28a-28g, 30a-30g are designed to detect the material to be spread SG1, SG2 discharged by the spreading discs 26a, 26b by receiving detection waves reflected by the material to be spread SG1, SG2 and to provide a sensor signal that depends on the intensity of the detection waves reflected by the material to be spread SG1, SG2. The sensors 28a-28g, 30a-30g are aligned such that the detection directions of the respective sensors 28a-28g, 30a-30g intersect the flight paths FB1, FB2 of the material to be spread SG1, SG2. The sensors 28a-28g, 30a-30g are also aligned such that the detection directions at least largely cover the usual angular range in which the material to be spread SG1, SG2 is discharged.

By evaluating the sensor signals of the sensors 28a-28g, 30a-30g, the control device 24 can determine the shape of the material spreading fans SF1, SF2 at the detection levels I, II.

The control device 24 is set up, for example, to adjust a first target distribution of the material to be spread SG1 at the first detection level I by a changing of one or more setting parameters of the discharge device 14, and to adjust a second target distribution of the material to be spread SG2 at the second detection level II. To adjust the target distributions, for example, the disc speed of the spreading discs 26a, 26b can be adjusted by the control device 24. Alternatively or additionally, the delivery point AP1, AP2 of the material to be spread SG1, SG2 delivered to the spreading discs 26a, 26b can be adjusted. The spreading discs 26a, 26b shown have adjustable centrifugal blades 32. With such spreading discs 26a, 26b, the position and/or length of the centrifugal blades 32 can also be changed to change the distribution of the material to be spread.

FIG. 4 shows that the detection direction 22 of the sensor arrangement 18 crosses the flight path FB1 of the first material to be spread SG1 in the first detection plane I, and crosses the flight path FB2 of the second material to be spread SG2 in the second detection plane II. The reflection distances D1, D2 result from the flight paths FB1, FB2 of the first and second materials to be spread SG1, SG2, and the orientation of the sensor arrangement 18 or the detection direction 22.

FIG. 5 shows that the control device 24 accumulates the intensity of the detection waves reflected from the material to be spread SG1, SG2 over the reflection distance D1, D2 to the material to be spread SG1, SG2 to determine the density distribution DV1 of the first material to be spread SG1 in the first detection plane I, and to determine the density distribution DV2 of the second material to be spread SG2 in the second detection plane II. By accumulation of the intensity of the detection waves reflected from the material to be spread SG1, SG2 over the reflection distance D1, D2, a curve KV1-KV7 is obtained for each sensor, from which it is possible to determine the density distributions DV1, DV2 of two material spreading fans SF1, SF2, which are spaced apart from one another in the detection direction 22.

The respective reflection distances D1, D2 are determined via the signal propagation times. The curves KV1-KV7 have a gradient of zero in the distance range between the two material spreading fans SF1, SF2. This range is therefore of particular importance to separate the two material spreading fans SF1, SF2 from one another in terms of signal technology without complicated filters. The curves KV1, KV2 have a positive gradient at the two detection levels I, II, i.e., in the distance range in which the two material spreading fans SF1, SF2 are located. From these gradients in the curves KV1-KV7 can be derived values for the density of the material to be spread I-1 to I-7 in the first detection level I and values for the density of the material to be spread II-1 to 1I-7 in the second detection level II. An evaluation of the gradients also allows the influence of wind to be determined, wherein material to be spread discharged against the direction of the wind has a comparatively steep gradient and material to be spread discharged with the direction of the wind has a comparatively flat gradient. Furthermore, by evaluating the length of the reflection distances D1, D2 in the respective detection planes I, II, a conclusion can be drawn about the influence of the wind, wherein a short length of the reflection distance D1, D2 indicates that the material to be spread is being discharged against the direction of the wind and a long length of the reflection distance D1, D2 indicates that the material to be spread is being discharged in the direction of the wind. These values for the densities of the material to be spread I-1 to I-7, II-1 to II-7 can then be used as the basis for a calculation routine for the density distributions of the material to be spread SG1, SG2 in the detection planes I, II.

FIG. 6 shows a system 10 in which the discharge device 14 comprises a disc arrangement 16. A mixture of materials to be spread is discharged onto the agricultural land F via the disc arrangement 16, the mixture of materials to be spread comprising a first material to be spread SG1 and a second material to be spread SG2. The mixture of materials to be spread can be a mixture of fertilizers, for example. During the flight phase, the material to be spread is separated so that the first material to be spread SG1 follows a first flight path FB1 and the second material to be spread SG2 follows a second flight path FB2. The material spreading fan SF1 containing the first material to be spread SG1 crosses the first detection level I. The material spreading fan SF2 containing the second material to be spread SG2 crosses the second detection level II. The system can thus be used to monitor the material spreading fans SF1, SF2 resulting from the separation of the mixture of fertilizers, so that the control device 24 can initiate the setting of setting parameters on the discharge device 14, through which the distribution of first material to be spread SG1 at the first detection level I and the distribution of the second material to be spread SG2 at the second detection level II are within a tolerance range.

FIG. 7 shows a system 10 in which the spreading machine 100 is designed as a carried machine. The carrier vehicle 200 and the spreading machine 100 form a machine combination. Otherwise, the system 10 shown in FIG. 7 is designed similarly to the system shown in FIG. 6.

FIG. 8 shows exemplary steps of a method for the delivery of material to be spread SG1, SG2 onto an agricultural land F.

In method step 300, material to be spread SG1, SG2 is delivered onto an agricultural land F by means of a discharge device 14 of the spreading machine 100.

Subsequently, in method step 302, the material to be spread SG1, SG2 delivered by the discharge device 14 is detected by receiving detection waves reflected by the material to be spread SG1, SG2 by means of a sensor arrangement 18 of the spreading machine 10.

Then, in step 304, several sensor signals dependent on the intensity of the detection waves reflected by the material to be spread SG1, SG2 are provided by the sensor arrangement 18.

In step 306, the density distribution DV1 of the material to be spread SG1 of a first material spreading fan SF1 crossing the first detection plane I is then determined by the control device 24 from the sensor signals.

Furthermore, in method step 308, the density distribution DV2 of the material to be spread SG2 of a second material spreading fan SF2 crossing the second detection plane II is determined by the control device 24 from the sensor signals.

To determine the density distributions DV1, DV2 of the material to be spread SG1, SG2 in the two spaced-apart detection planes I, II, the control device 24 evaluates the intensity of the detection waves reflected by the material to be spread SG1, SG2 as a function of the reflection distance D1, D2 to the material to be spread SG1, SG2.

In method step 310, a change in a setting parameter of the discharge device 14 that influences the distribution of the material to be spread is initiated by the control device 24 as a function of the sensor signals provided by the sensor arrangement 18 to achieve an intended distribution of the material to be spread onto the agricultural land F.

### REFERENCE SYMBOLS

10 System
12 Storage region
14 Discharge device
16, 16a, 16b Disc arrangements
18 Sensor arrangement
20, 20a, 20b Sensor holders
22 Detection direction
24 Control device
26a, 26b Spreading discs
28a-28g Sensors
30a-30g Sensors
32 Centrifugal blades
100 Spreading machine
200 Towing or carrier vehicle
300-310 Method steps
I, II Detection levels
I-1 to I-7 Values for the density of the material to be spread
II-1 to II-7 Values for the density of the material to be spread
F Agricultural land
FB1, FB2 Flight paths
FR Direction of travel
AP1, AP2 Delivery points
SF1, SF2 Material spreading fans
SG1, SG2 Material to be spread
D1. D2 Reflection distances
DV1, DV2 Density distributions
KV1-KV7 Curves

1. A fertilizer spreader for delivering granular fertilizer onto an agricultural land, comprising:
a discharge device having at least one disc arrangement which is designed to discharge fertilizer onto the agricultural land;
a sensor arrangement comprising a plurality of sensors, the plurality of sensors each being designed to detect the fertilizer discharged by the discharge device by emitting detection waves in the direction of the fertilizer discharged by the discharge device and receiving detection waves reflected by the fertilizer, and to provide a sensor signal dependent on the intensity of the detection waves reflected by the fertilizer; and
a control device which, to achieve an intended fertilizer distribution on the agricultural land, is designed to cause a change in the disc speed on one or more spreading discs of the disc arrangement and/or the point at which the fertilizer is applied to one or more spreading discs of the disc arrangement depending on the sensor signals provided by the sensors of the sensor arrangement;
wherein the control device is set up to evaluate the intensity of the detection waves reflected by the fertilizer depending on the reflection distance between the respective sensor and the fertilizer to determine the fertilizer distribution in two detection planes spaced apart from one another.

2. A system for the delivery of material to be spread on an agricultural land, having
a discharge device which is designed to discharge material to be spread onto the agricultural land;
a sensor arrangement which is designed to detect the material to be spread discharged by the discharge device by receiving detection waves reflected by the material to be spread, and to provide at least one sensor signal which is dependent on the intensity of the detection waves reflected by the material to be spread; and
a control device which is designed to achieve an intended distribution of material to be spread onto the agricultural land to cause a change in a setting parameter of the discharge device which influences the distribution of material to be spread depending on the sensor signal provided by the sensor arrangement;
wherein the control device is set up to evaluate the intensity of the detection waves reflected by the material to be spread as a function of the reflection distance to the material to be spread to determine the density distribution of the material to be spread in two detection planes spaced apart from one another.

3. The system according to claim 2,
wherein the control device is set up to accumulate the intensity of the detection waves reflected by the material to be spread over the reflection distance to the material to be spread to determine the density distribution of the material to be spread in the two detection planes spaced apart from one another.

4. The system according to claim 2,
wherein the sensor arrangement comprises a plurality of sensors which are spaced apart from one another and/or have different orientations, each of which is designed to detect the material to be spread discharged by the discharge device by receiving detection waves reflected by the material to be spread and to provide a sensor signal which depends on the intensity of the detection waves reflected by the material to be spread.

5. The system according to claim 4,
wherein the control device is designed to determine from the sensor signals of the plurality of sensors
the density distribution of the material to be spread and/or the fan shape and/or the transverse distribution of the material to be spread of a first material spreading fan crossing the first detection plane; and/or
the density distribution of the material to be spread and/or the fan shape and/or the transverse distribution of the material to be spread of a second material spreading fan crossing the second detection plane.

6. The system according to claim 2,
wherein the control device is designed to regulate a first target distribution of the material to be spread at the first detection level and/or to regulate a second target distribution of the material to be spread at the second detection level by a changing of one or more setting parameters of the discharge device.

7. The system according to claim 2,
wherein the discharge device has a first disc arrangement for producing a first material spreading fan and a second disc arrangement for producing a second material spreading fan, wherein the first material spreading fan crosses the first detection plane and the second material spreading fan crosses the second detection plane.

8. The system according to claim 7,
wherein
a first storage container for storing a first material to be spread; and/or
a first delivery device for delivering the first material to be spread stored in the first storage container onto the first disc arrangement; and/or
a second storage container for storing a second material to be spread; and/or
a second delivery device for delivering the second material to be spread stored in the second storage container onto the second disc arrangement.

9. The system according to claim 2,
wherein
the discharge device has a disc arrangement for producing a material spreading fan, wherein the material spreading fan crosses the first detection plane and the second detection plane; or
the discharge device comprises a disc arrangement, wherein when a material to be spread mixture comprising a first material to be spread and a second material to be spread is delivered, a first material spreading fan and a second material spreading fan are formed due to a segregation of the material to be spread, wherein the first material spreading fan crosses the first detection plane and the second material spreading fan crosses the second detection plane.

10. An agricultural spreading machine, having
a system for material to be spread to be delivered onto an agricultural land;
wherein the system is designed according to claim 2.

11. A method for delivering material to be spread onto an agricultural land by means of an agricultural spreading machine, in particular by means of an agricultural spreading machine according to claim 10, with the steps:
discharging material to be spread onto an agricultural land by means of a discharge device of the spreading machine;
detecting the material to be spread discharged by the discharge device by receiving detection waves reflected by the material to be spread by means of a sensor arrangement of the spreading machine
providing at least one sensor signal dependent on the intensity of the detection waves reflected by the material to be spread by the sensor arrangement; and
initiating a change in a setting parameter of the discharge device that influences the distribution of the material to be spread as a function of the sensor signal provided by the sensor arrangement to achieve an intended distribution of the material to be spread onto the agricultural land by a control device of the spreading machine,
wherein the control device evaluates the intensity of the detection waves reflected by the material to be spread as a function of the reflection distance to the material to be spread to determine the density distribution of the material to be spread in two detection planes spaced apart from one another.

12. The method according to claim 11,
wherein the control device for determining the density distribution of the material to be spread in the two detection planes spaced apart from one another accumulates the intensity of the detection waves reflected from the material to be spread over the reflection distance to the material to be spread.

13. The method according to claim 11,
wherein a plurality of spaced-apart and/or differently oriented sensors of the sensor arrangement detect the material to be spread delivered by the discharge device by receiving detection waves reflected by the material to be spread, and provide a sensor signal dependent on the intensity of the detection waves reflected by the material to be spread, wherein the method comprises at least one of the following steps:
determining the density distribution of the material to be spread and/or the fan shape and/or the transverse distribution of the material to be spread of a first material spreading fan crossing the first detection plane by the control device from the sensor signals of the plurality of sensors;
determining the density distribution of the material to be spread and/or the fan shape and/or the transverse distribution of the material to be spread of a second material spreading fan crossing the second detection plane by the control device from the sensor signals of the multiple sensors.

14. The method according to claim 11;
characterised by at least one of the following steps:
adjusting a first target distribution of the material to be spread in the first detection plane by a changing one or more setting parameters of the discharge device by the control device;
adjustment of a second target distribution of the material to be spread in the second detection plane by a changing of one or more setting parameters of the discharge device by the control device.

15. The method according to claim 11;
wherein the discharge device generates a material spreading fan which crosses the first detection plane and the second detection plane, the method preferably comprising the following step:
determining the wind influence on the material spreading fan by evaluating the distribution of the material to be spread in the first detection plane and the second detection plane by the control device, wherein the control device preferably takes the determined wind influence into account when adjusting the discharge device.

16. The method according to claim 11;
wherein when a mixture of materials to be spread comprising a first material to be spread and a second material to be spread is discharged, a first material spreading fan and a second material spreading fan are formed due to a segregation of the materials to be spread, wherein the first material spreading fan crosses the first detection plane and the second material spreading fan crosses the second detection plane, wherein the method preferably comprises the following step:
setting of setting parameters on the discharge device by the control device, through which the distribution of the first material to be spread in the first detection plane and the distribution of the second material to be spread in the second detection plane lie within a tolerance range.
